(19) United States
(12) Patent Application Publication
(10) Pub. No.: US 2006/0187906 A1
(43) Pub. Date: Aug. 24, 2006

(54) Controlling service failover in clustered storage apparatus networks

(76) Inventors: Bharat Veer Bedi, Hant (GB); Andrew James Stanford-Clark, Isle of Wight (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/351,139

(22) Filed: Feb. 9, 2006

(30) Foreign Application Priority Data
Feb. 9, 2005 (GB) 0502703.2

(51) Int. Cl. H04L 12/66

(52) U.S. Cl. 370/352

(57) ABSTRACT

A controller for use at a node of a clustered computer apparatus comprises an exception detection component for detecting an exception raised by a service component at the node; a quiesce component responsive to the exception detection component for quiescing lease-governed activity by the service component prior to termination of a lease; a lease control component responsive to the quiesce component for pre-expiry relinquishing of the lease; and a communication component responsive to the lease control component for communicating the pre-expiry relinquishing of the lease to one or more further nodes of said clustered computer apparatus. The controller may further comprise a further communication component for receiving a communication indicating the pre-expiry relinquishing of a lease; a further lease control component responsive to the communication to control failure processing; and a further service component to perform a service in place of the service component at the node.

### FIELD OF THE INVENTION

The present invention relates to controlling failover in storage apparatus, and more particularly to controlling failover in clustered storage apparatus networks.

### BACKGROUND OF THE INVENTION

The concept of clustering of computer systems is well-known in the art. Nevertheless, a brief summary of the background may be helpful in understanding the present invention in its preferred embodiments.

A cluster consists of a group of computer systems (henceforth known as ‘nodes’) that operate together to provide a service to one or more clients or applications. One of the benefits of clustered systems is the ability to continue operation in the face of failure to one or more nodes within the cluster: in the event of some nodes within the cluster failing the work being performed by these nodes is redistributed to the surviving members of the cluster. Even with node failures the cluster continues to offer a service to its clients, although typically with reduced performance.

With most clustered systems it is necessary to prevent a cluster which is split into two groups of nodes from allowing both groups of nodes to continue operating as independent clusters. This problem is normally solved by introducing the concept of a quorum—a minimal set of nodes required for the cluster to continue operation. When a cluster of nodes is partitioned into two groups one group will maintain a quorum and will continue operating while the other group will be inquorate and will cease to participate in the cluster. To achieve this each node in the cluster needs to check that it is still part of the quorum as it processes service requests so that as soon as it determines it is in an inquorate group it stops participating in the cluster. This is typically achieved either by using heartbeats or a lease. The concepts of heartbeats and leases as means for controlling connected systems are well-known in the art, but, for better understanding of the present disclosure, a brief introduction to the relevant concepts related to leases is offered here.

A lease permits a node to offer a service on behalf of the cluster without having to refer to its cluster peers to service each request. The lease defines a time-limited period during which the node can offer the service without further reference to the peers. An infrequent message can be used to extend the lease, so that the node can continue to offer the service for a long period. In the event of a loss of communications with a node that has been granted a lease, the peer nodes of the prior art typically wait for a period of time not less than the lease before being assured that the node has stopped participating in the cluster and allowing the transfer of work from the failing node to surviving nodes within the cluster.

The concept of lease is particularly valuable in clustered systems which must present a coherent image of some changing information, and in which requests to view that information must be serviced with minimal cost, certainly less than that required to correspond with other nodes.

The lease time defines the minimum period during which a service is unavailable following a failure (henceforth ‘failover time’). Even short periods of unavailability will appear as glitches in system operation which will decrease customer satisfaction. Minimising this time improves the quality of the system. The shorter the lease time used by the cluster the faster the failover time. However the shorter the lease time the more frequently nodes within the cluster need to extend the lease and consequently the greater the overheads are for maintaining the lease. The minimum lease time is also bounded by the speed of communications between nodes—the lease time cannot be less than the time it takes to communicate a lease extension. Therefore, while it is desirable to have a very short lease time to minimise the failover time, in practice this is often not possible.

The governing of systems using leases ensures correct operation in the face of almost any failure (it is dependent on the correct operation of a clock). However, it is a rather conservative measure, and there is a particular class of system failure which is common and where it would be desirable to avoid the overhead of a lease operation, namely that of software failure caused by an ‘assert’—a form of failure where the software itself has detected some illegal or unexpected situation and has determined it is safer to exit and restart than to continue operation.

The normal method for improving failover time in a lease-based system is to make the lease time as short as possible. The disadvantage of this method is that the more frequently a lease needs to be renewed, the higher the overheads are for maintaining the lease. The minimum lease time cannot be less than the time it takes to communicate a lease extension. Many clustered systems require dedicated hardware to allow nodes in the cluster to communicate lease extensions as quickly as possible.

### SUMMARY OF THE INVENTION

The present invention provides, in a first aspect, a controller for use at a node of a clustered computer apparatus, comprising: an exception detection component for detecting an exception raised by a service component at said node; a quiesce component responsive to said exception detection component for quiescing lease-governed activity by said service component prior to termination of a lease; a lease control component responsive to said quiesce component for pre-expiry relinquishing of said lease; and a communication component responsive to said lease control component for communicating the pre-expiry relinquishing of said lease to one or more further nodes of said clustered computer apparatus.

The controller may further comprise: a further communication component for receiving a communication indicating the pre-expiry relinquishing of a lease; a further lease control component responsive to said communication to control failure processing; and a further service component to perform a service in place of said service component at said node.

Preferably, said exception detection component, said quiesce component and said lease control component are located in a layer above a clustering layer, and said communication component is located in said clustering layer.

Preferably, said further communication component is located in a clustering layer, and said further lease control component and said further service component are located in a layer above said clustering layer.

The controller is preferably adapted to control a storage apparatus.

The controller is preferably adapted to control virtualization of said storage apparatus.

In a second aspect, the present invention provides a method of operating a controller for use at a node of a clustered computer apparatus, comprising steps of: detecting, by an exception detection component, an exception raised by a service component at said node; quiescing, by a quiesce component responsive to said exception detection component, lease-governed activity by said service component prior to termination of a lease; pre-expiry relinquishing, by a lease control component responsive to said quiesce component, of said lease; and communicating, by a communication component responsive to said lease control component, the pre-expiry relinquishing of said lease to one or more further nodes of said clustered computer apparatus.

The method preferably further comprises steps of: receiving, by a further communication component, a communication indicating the pre-expiry relinquishing of a lease; controlling failure processing by a further lease control component responsive to said communication; and performing, by a further service component, a service in place of said service component at said node.

Preferably said steps of detecting, quiescing and pre-expiry relinquishing are performed in a layer above a clustering layer, and said step of communicating is performed in said clustering layer.

Preferably said step of receiving is performed in a clustering layer, and said steps of controlling and performing a service are performed in a layer above said clustering layer.

The method preferably further comprises controlling a storage apparatus.

The method preferably further comprises controlling virtualization of said storage apparatus.

In a third aspect, the present invention provides a computer program comprising computer program code to, when loaded into a computer system and executed thereon, cause said computer system to perform the steps of a method according to the second aspect.

The preferred embodiments of the invention intercept the software at the layer that processes the exception condition, and insert extra processing at this step. The extra steps include: ensuring the software on the local node is properly quiesced, such that the lease is no longer needed; sending a message to the other nodes in the system to say that the node has correctly quiesced and is no longer participating in the cluster; and allowing the other nodes in the cluster on the basis of receipt of that message to continue operation without waiting for the lease to expire.

In a preferred implementation, the software can be considered as two elements, a clustering layer including messaging, and a higher-level application software layer that is providing service that relies on the clustering. The higher-level software is responsible for a significant percentage of the system failures due to software. Thus, advantageously, the preferred embodiments of the present invention address and ameliorate this preponderance of failures in such a system.

In the event of an exception detected in the higher-level layer, the software that processes exceptions quiesces operation of the higher-level software in such a way that it can be assured that all lease-related activity has ceased. Once this process has completed successfully, the exception processing code invokes the cluster layer to tell it that the system has quiesced. The clustering layer then informs the peer nodes that the node is exiting gracefully by sending a message, before the failing node exits.

The peer nodes receive the message from the failed nodes, and reset (set to zero) the timers that indicate the lease time that remains. They then process the failure of the node as normal, but omit the phase where they wait for the lease to expire.

By thus transferring service in a ‘controlled’ way rather than the ‘uncontrolled’ way associated with a failure, the lease time period of non-availability can be avoided. This transfer must ensure that the service is shutdown in a controlled fashion, and that the stopping node communicates this before the service is started on a second node.

The preferred embodiments of the invention advantageously do not require the guaranteed transmission of the message before the failing node exits to ensure correct operation of the cluster. If the software failure is severe enough that it is not possible to transmit the message, then the failover occurs when the lease for the failing node has expired, as in the known systems of the prior art. This means that if an implementation of the invention can only successfully transmit the message N % of the time then the cluster will have a faster failover time for N % of node failures and will have the longer lease-based failover time according to conventional processing for the remainder of node failures.

### BRIEF DESCRIPTION OF THE DRAWINGS

A preferred embodiment of the present invention will now be described, by way of example only, with reference to the accompanying drawing figures, in which:

FIG. 1 shows in schematic form one type of apparatus in which the present invention may be embodied; and

FIG. 2 shows a flow diagram of a method for operating a controller according to a preferred embodiment of the present invention.

### DETAILED DESCRIPTION OF THE PREFERRED EMBODIMENT

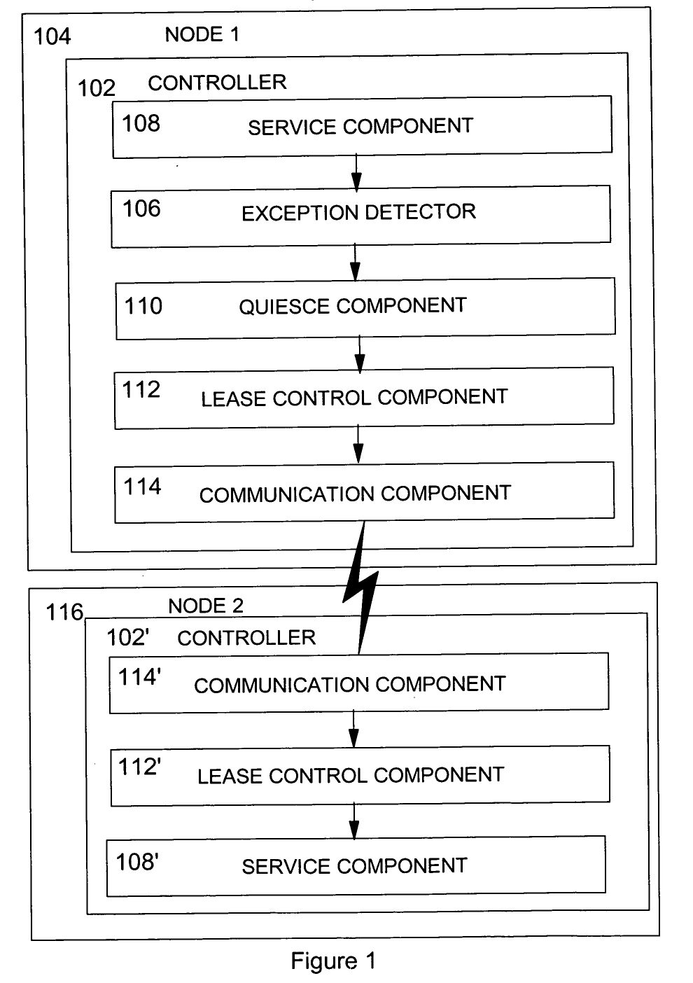

Turning now to FIG. 1, there is shown an exemplary apparatus in which a preferred embodiment of the present invention may be implemented.

FIG. 1 shows a controller 102 for use at a node 104 of a clustered computer apparatus. The controller 102 comprises an exception detection component 106 for detecting an exception raised by a service component 108 at node 104, a quiesce component 110, which is responsive to the exception detection component 106 for quiescing lease-governed activity by service component 108 prior to the termination of its lease. The controller also comprises a lease control component 112 responsive to quiesce component 110 for pre-expiry relinquishing of the lease, and a communication component 114 responsive to the lease control component 112 for communicating the pre-expiry relinquishing of the lease to one or more further nodes 116 of the clustered computer apparatus.

The controller shown in FIG. 1 may also comprise a further communication component 114′ for receiving a communication indicating the pre-expiry relinquishing of a lease; a further lease control component 112′ responsive to the communication to control failure processing; and a further service component 108′ to perform a service in place of the original service component 108 at the original node 104.

It will be clear from the foregoing to any person of ordinary skill in the art that, while the functional elements of the preferred embodiment of the present invention have been described in terms of discrete components, they may equally be implemented in various combinations of integrated or discrete components which may be linked by electrical or electronic means or by any equivalent means for communicating control and information therebetween.

In preferred embodiments, the controller of FIG. 1 comprises both the components implementing the functions of NODE 1 and those implementing the functions of NODE 2. It will be clear to one of ordinary skill in the art that, while this is preferred, the functions may be separated according to the requirements of the individual system.

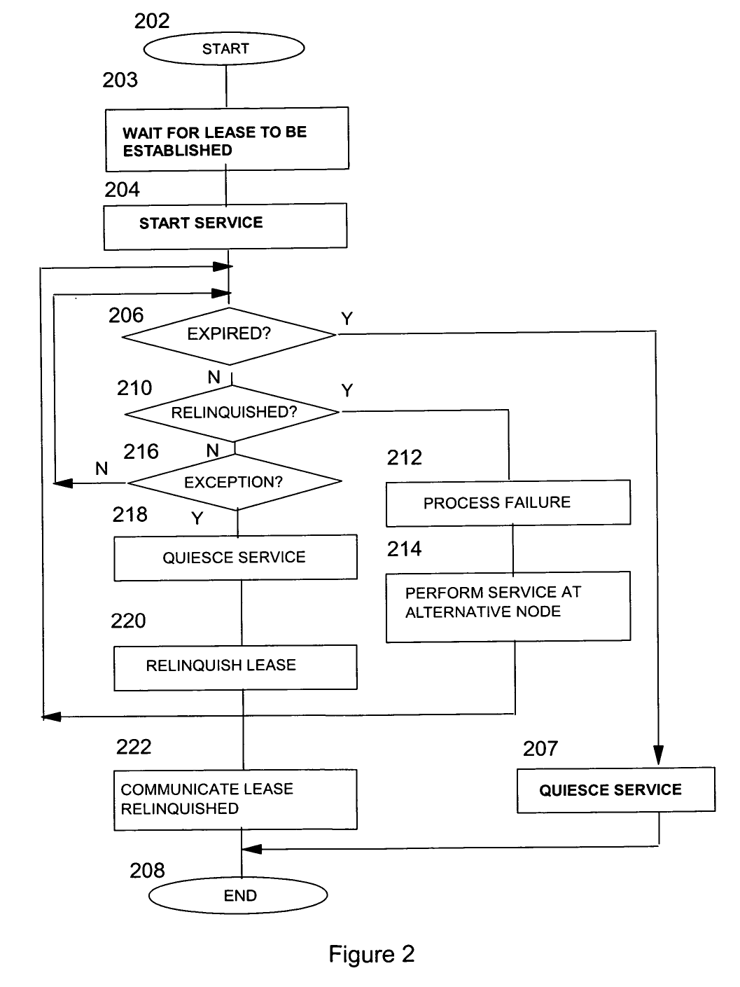

Turning now to FIG. 2, there is shown a flow diagram of a system governed by leases in which a preferred embodiment of the present invention may be implemented.

The method begins conventionally at step 202, and at step 203 a lease is awaited (a lease may be newly granted or renewed) as in a conventional system according to the prior art. When a lease is established, at step 204, one or more lease-governed services are started. Conventionally, also, at step 206, a test is performed to determine if a lease has expired. If so, the process quiesces the service at step 207 and proceeds to end step 208 in the conventional manner. If the lease has not expired, a test is performed at step 210 to determine whether a lease has been relinquished by a communicating node. If so, the failure is processed at step 212 and at step 214 the service is performed by an alternative node. The process then returns to the test at step 206 and continues. It will be clear to one skilled in the art that, in multiprocessor systems, the service may equally be performed by the same node, but in an alternative processor. Variations and modifications will naturally occur to one of ordinary skill in the art. The process proceeds then to end step 208 in a conventional manner.

If no relinquished lease has been detected at step 210, a test is performed to determine whether an exception has been detected within the local software service layer. If not, processing continues by returning to a point prior to step 206. If an exception has been detected, the service is quiesced at step 218. On completion of the quiesce process, the unexpired lease is relinquished at step 220. At step 222, the notification that the lease has been relinquished is communicated to a communicating node, and the process completes at end step 208. In the communicating node, as described above, the notification is detected at step 210, and processing continues as previously outlined.

Thus, in summary, there is shown a method of operating a controller for use at a node of a clustered computer apparatus, comprising steps of: detecting, by an exception detection component, an exception raised by a service component at the node; quiescing, by a quiesce component responsive to the exception detection component, lease-governed activity by the service component prior to termination of a lease; pre-expiry relinquishing, by a lease control component responsive to the quiesce component, of the lease; and communicating, by a communication component responsive to the lease control component, the pre-expiry relinquishing of the lease to one or more further nodes of the clustered computer apparatus.

A node may be further adapted to perform the additional steps of receiving, by a further communication component, a communication indicating the pre-expiry relinquishing of a lease; controlling failure processing by a further lease control component responsive to the communication; and performing, by a further service component, a service in place of the service component at the original node.

It will be clear to one skilled in the art that the method of the present invention may suitably be embodied in a logic apparatus comprising logic means to perform the steps of the method, and that such logic means may comprise hardware components or firmware components.

It will be appreciated that the method described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will be further appreciated that embodiments of the present invention may be provided in the form of a service deployed on behalf of a customer to offer offsite disaster recovery services.

It will also be appreciated that various further modifications to the preferred embodiment described above will be apparent to a person of ordinary skill in the art.

1. A controller for use at a node of a clustered computer apparatus, comprising:
an exception detection component for detecting an exception raised by a service component at said node;
a quiesce component responsive to said exception detection component for quiescing lease-governed activity by said service component prior to termination of a lease;
a lease control component responsive to said quiesce component for pre-expiry relinquishing of said lease; and
a communication component responsive to said lease control component for communicating the pre-expiry relinquishing of said lease to one or more further nodes of said clustered computer apparatus.

2. The controller as claimed in claim 1, further comprising:
a further communication component for receiving a communication indicating the pre-expiry relinquishing of a lease;
a further lease control component responsive to said communication to control failure processing; and
a further service component to perform a service in place of said service component at said node.

3. The controller as claimed in claim 1, wherein said exception detection component, said quiesce component and said lease control component are located in a layer above a clustering layer, and said communication component is located in said clustering layer.

4. The controller as claimed in claim 2, wherein said further communication component is located in a clustering layer, and said further lease control component and said further service component are located in a layer above said clustering layer.

5. The controller as claimed in claim 1, adapted to control a storage apparatus.

6. The controller as claimed in claim 5, further adapted to control virtualization of said storage apparatus.

7. A method of operating a controller for use at a node of a clustered computer apparatus, comprising steps of:
detecting, by an exception detection component, an exception raised by a service component at said node;
quiescing, by a quiesce component responsive to said exception detection component, lease-governed activity by said service component prior to termination of a lease;
pre-expiry relinquishing, by a lease control component responsive to said quiesce component, of said lease; and
communicating, by a communication component responsive to said lease control component, the pre-expiry relinquishing of said lease to one or more further nodes of said clustered computer apparatus.

8. The method as claimed in claim 7, further comprising steps of:
receiving, by a further communication component, a communication indicating the pre-expiry relinquishing of a lease;
controlling failure processing by a further lease control component responsive to said communication; and
performing, by a further service component, a service in place of said service component at said node.

9. The method as claimed in claim 7, wherein said steps of detecting, quiescing and pre-expiry relinquishing are performed in a layer above a clustering layer, and said step of communicating is performed in said clustering layer.

10. The method as claimed in claim 8, wherein said step of receiving is performed in a clustering layer, and said steps of controlling and performing a service are performed in a layer above said clustering layer.

11. The method as claimed in claim 7, further comprising controlling a storage apparatus.

12. The method as claimed in claim 11, further comprising controlling virtualization of said storage apparatus.

13. A computer program comprising computer program code to, when loaded into a computer system and executed thereon, cause said computer system to perform the steps of the method as claimed in any of steps 7 to 12.
